(19) United States
(12) Patent Application Publication
(10) Pub. No.: US 2014/0143541 A1
(43) Pub. Date: May 22, 2014

(54) Method and Apparatus for Managing Encrypted Files in Network System

(71) Applicant: Cloudioh Inc., Taipei City (TW)

(72) Inventor: Yan-Cheng Chang, New Taipei City (TW)

(73) Assignee: Cloudioh Inc., Taipei City (TW)

(21) Appl. No.: 13/901,589

(22) Filed: May 24, 2013

Related U.S. Application Data
(60) Provisional application No. 61/728,237, filed on Nov. 20, 2012.

(51) Int. Cl. G06F 21/60

(52) U.S. Cl. CPC G06F 21/602
USPC 713/165

(57) ABSTRACT

A method for managing a file in a remote folder in a shared storage in a network system is disclosed. The method comprises generating a symmetric cryptographic key for the file; generating a ciphertext according to a symmetric encrypting function of the file operating with the symmetric cryptographic key for the file; generating a metadata according to the symmetric encrypting function of the symmetric cryptographic key for the file operating with a symmetric cryptographic key for the remote folder; and uploading the ciphertext and the metadata to the remote folder.

### CROSS REFERENCE TO RELATED APPLICATIONS

This application claims the benefit of U.S. Provisional Application No. 61/728,237, filed on Nov. 20, 2012, entitled “Secure and Efficient Systems for Operations against Encrypted Files”, the contents of which are incorporated herein in their entirety.

### BACKGROUND OF THE INVENTION

1. Field of the Invention

The present invention relates to a method and apparatus utilized in a network system, and more particularly, to a method and apparatus of managing an encrypted file in a shared storage in a network system.

2. Description of the Prior Art

Nowadays, users often collaborate on computer files in a shared storage provided by an internal corporate information technology department or an external service provider, such as Box, Dropbox or Google Drive. For example, if a file is stored in Google Drive, a collaborator who works on a local copy of the file in a personal computer using certain computer software can update the remote version in Google Drive with his local version. And other collaborators can further access the new version of the file.

For privacy and confidentiality reasons, encrypting the file is desirable before uploading the file to the shared storage. Accordingly, it is necessary to make sure the collaborators have correct access rights to maintain the encrypted file while the secret cryptographic keys are only known to the collaborators.

With respect to encryption, an asymmetric encrypting algorithm uses both public and secret cryptographic keys, such as an RSA algorithm, while a symmetric encrypting algorithm uses secret cryptographic keys only, such as an AES algorithm. In practice, one should take special care of the issue of initialization vector (IV). An IV is a block of bits that is used to randomize the encryption and hence to produce distinct ciphertexts even if the same plaintext is encrypted multiple times, without the need for a slower re-keying process. Most symmetric cryptographic algorithms require anew random IV every time they are used for encryption. And such IVs have to he stored alone with ciphertexts so that decryption is possible.

Therefore, due to the intrinsic complexity of such a system, how to securely share and efficiently manage the secret cryptographic keys becomes an important issue.

### SUMMARY OF THE INVENTION

The present invention therefore provides a method and apparatus for managing a file in a shared storage in a network system, to keep the file secure and confidential. Without loss of generality we assume each such file resides in a remote (file) folder which is associated with a symmetric cryptographic key only known to collaborators. Such a symmetric cryptographic key for the remote folder can be maintained in any way.

A method for managing a file in a remote folder in a shared storage in a network system is disclosed. The method comprises generating a symmetric cryptographic key for the file; generating a ciphertext according to asymmetric encrypting function of the file operating with the symmetric cryptographic key for the file; generating a metadata according to the symmetric encrypting function of the symmetric cryptographic key for the file operating with a symmetric cryptographic key for the remote folder; and uploading the ciphertext and the metadata to the remote folder.

A computer readable medium comprising multiple instructions stored in a computer readable device is disclosed. Upon executing these instructions, a computer performs the following steps: generating a symmetric cryptographic key for a file; generating a ciphertext according to a symmetric encrypting function of the file operating with the symmetric cryptographic key for the file; generating a metadata according to the symmetric encrypting function of the symmetric cryptographic key for the file operating with a symmetric cryptographic key for the remote folder; and uploading the ciphertext and the metadata to the remote folder.

A computer apparatus for a network system is disclosed. The computer apparatus comprises a processing means; a storage unit; and a program code, stored in the storage unit, wherein the program code instructs the processing means to execute the following steps: generating a symmetric cryptographic key for a file; generating a ciphertext according to a symmetric encrypting function of the file operating with the symmetric cryptographic key for the file; generating a metadata according to the symmetric encrypting function of the symmetric cryptographic key for the file operating with a symmetric cryptographic key for the remote folder; and uploading the ciphertext and the metadata to the remote folder.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a network system according to an example of the present invention.

FIG. 2 is a schematic diagram of a computer apparatus according to an example of the present invention.

FIGS. 3-6 are flowcharts of processes according to examples of the present invention.

### DETAILED DESCRIPTION

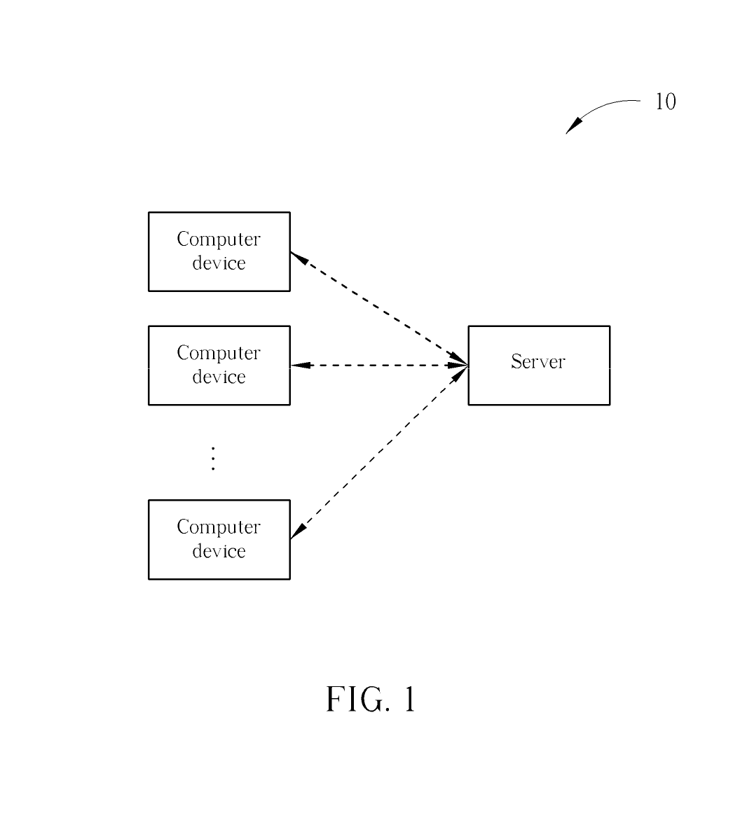

Please refer to FIG. 1, which is a schematic diagram of a network system 10 according to an example of the present invention. The network system 10 is briefly composed of a server and a plurality of computer devices. In FIG. 1, the server and the computer devices are simply utilized for illustrating the structure of the network system 10. Practically, the server can be an internal corporate information technology or an external service provider, such as Box, Dropbox or Google Drive, providing a shared storage. Besides, users can manage the shared storage by remote access in the computer devices.

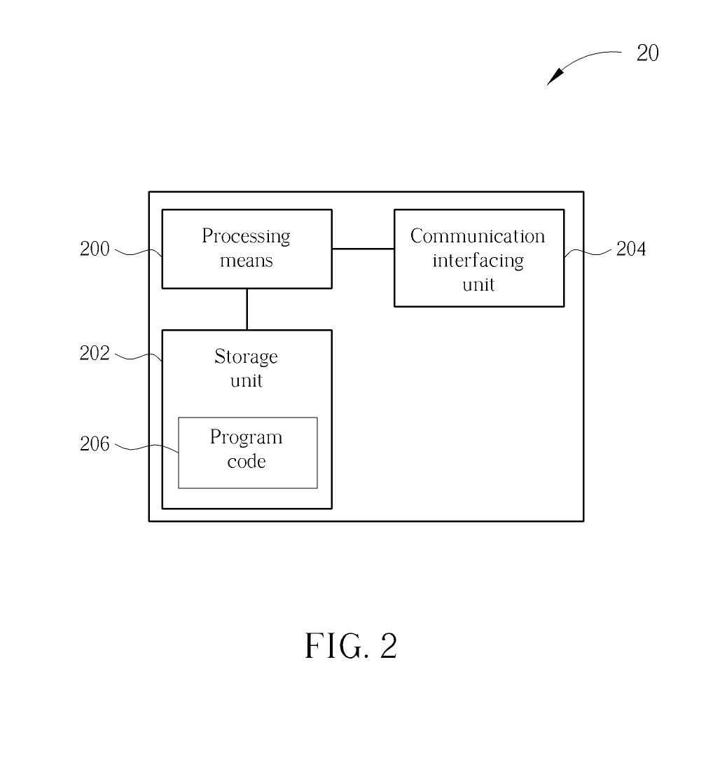

Please refer to FIG. 2, which is a schematic diagram of a computer apparatus 20 according to an example of the present invention. The computer apparatus 20 can be one of the computer devices shown in FIG. 1, but is not limited thereto. The computer apparatus 20 may include a processing means 200 such as a microprocessor or Application Specific Integrated Circuit (ASIC), a storage unit 202 and a communication interfacing unit 204. The storage unit 202 may be any data storage device that can store a program code 206, accessed and executed by the processing means 200. Examples of the storage unit 202 include but are not limited to read-only memory (ROM), flash memory, random-access memory (RAM), CD-ROM/DVD-ROM, magnetic tape, hard disk and optical data storage device. The communication interfacing unit 204 is preferably a transceiver and is used to transmit and receive signals (e.g., messages or packets) according to processing results of the processing means 200.

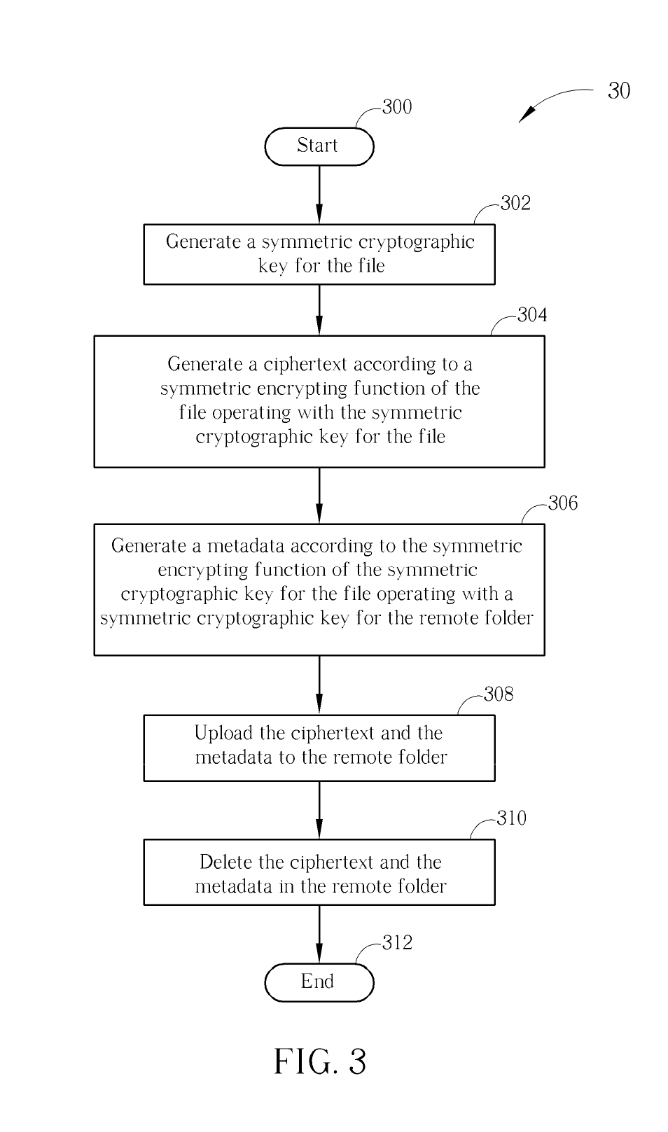

Please refer to FIG. 3, which is a flowchart of a process 30 according to an example of the present invention. The process 30 is utilized in the network system 10 shown in FIG. 1, for managing a file in a remote folder in the shared storage by one of the computer devices, to securely access the file by collaborators having the access right. The process 30 can be implemented in the computer apparatus 20 and may be compiled into the program code 206. The process 30 includes the following steps:

Step 300: Start.

Step 302: Generate a symmetric cryptographic key for the file.

Step 304: Generate a ciphertext according to a symmetric encrypting function of the file operating with the symmetric cryptographic key for the file.

Step 306: Generate a metadata according to the symmetric encrypting function of the symmetric cryptographic key for the file operating with a symmetric cryptographic key for the remote folder.

Step 308: Upload the ciphertext and the metadata to the remote folder.

Step 310: Delete the ciphertext and the metadata in the remote folder.

Step 312: End.

According to the process 30, the computer device generates the ciphertext and the metadata according to the file, the symmetric cryptographic key for the file and the symmetric cryptographic key for the remote folder. Moreover, a period from the creation to the deletion of the file in the remote folder is regarded as a lifecycle of the file. Therefore, the collaborators can access the encrypted file in the remote folder and keep the file securely and confidentially in the lifecycle of the file.

However, the collaborators who have access to the symmetric cryptographic key for the remote folder may also execute other operations, such as an updating operation, a downloading operation and a moving operation. In detail, for updating operation, the uploader generates an updated ciphertext according to the symmetric encrypting function of an updated file operating with the symmetric cryptographic key for the file and further uploads the updated ciphertext to the remote folder as a new version.

Besides, for the downloading operation, a downloader is allowed to download the file when the downloader has access to the symmetric cryptographic key for the remote folder. The downloader can download the file from the remoter folder by downloading the ciphertext and the metadata from the remote folder and obtaining the file according to a symmetric decrypting function of the ciphertext operating with the symmetric cryptographic key for the file, which is obtained according to a symmetric decrypting function of the metadata operating with the symmetric cryptographic key for the remote folder.

Moreover, for the moving operation, the collaborators may move the ciphertext and the metadata from the remote folder to the target folder and replace the metadata by a new metadata according to the symmetric encrypting function of the symmetric cryptographic key for the file operating with a symmetric cryptographic key for the target folder.

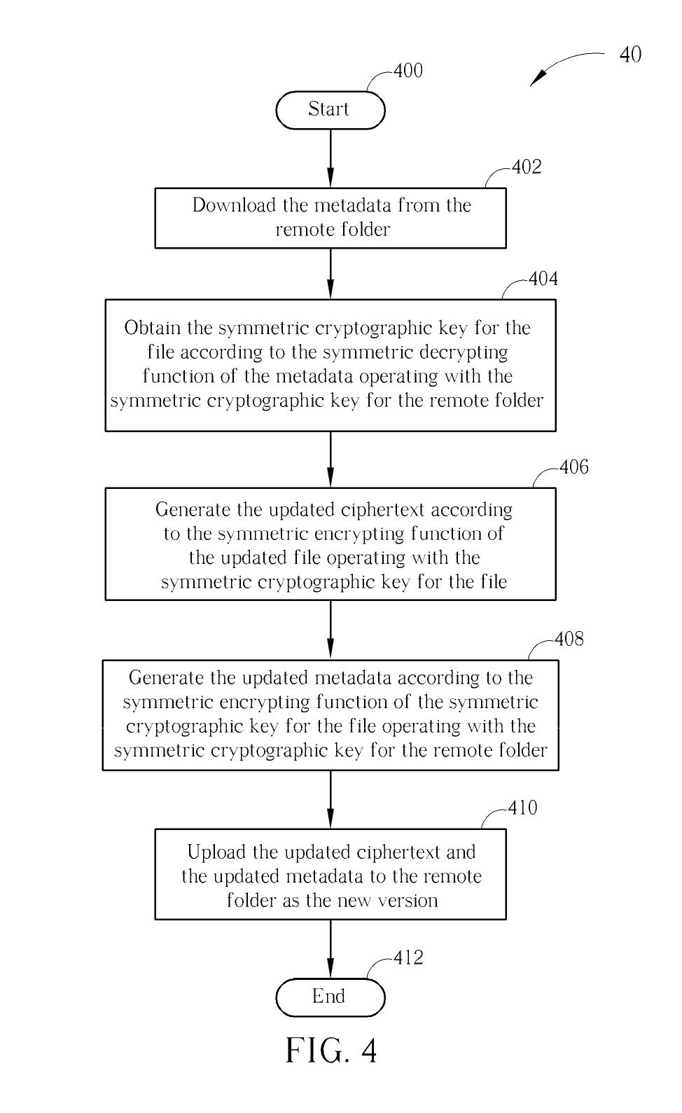

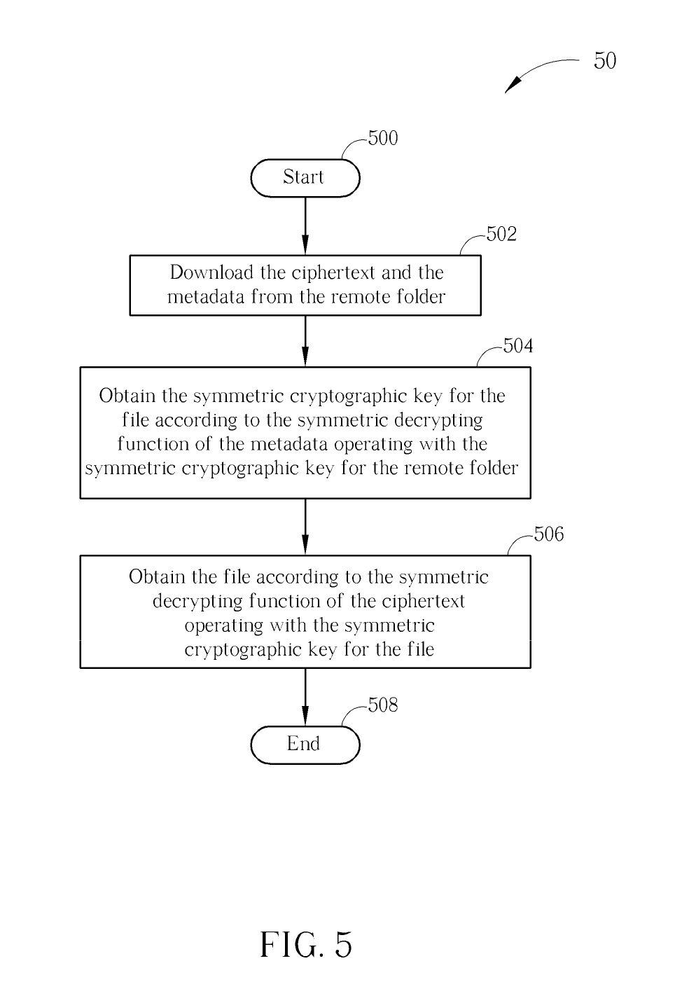

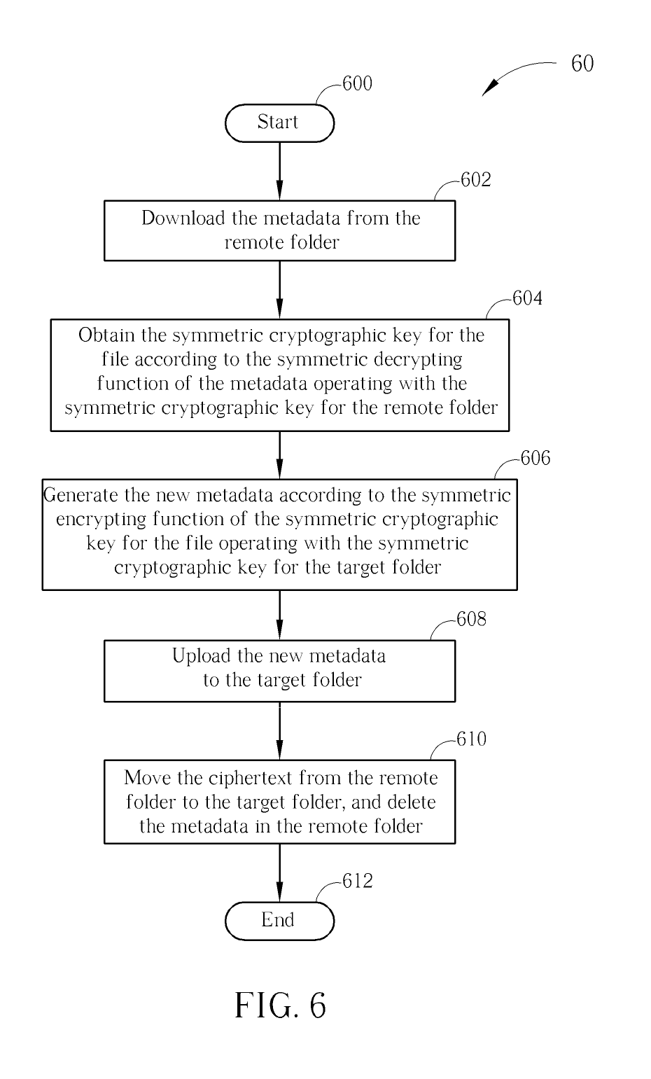

As seen from the above, the updating, downloading and moving operations can be summarized to processes 40, 50 and 60, as shown in FIGS. 4-6. The processes 40, 50 and 60 can be implemented in the computer apparatus 20 and may be compiled into the program code 206. The process 40 includes the following steps:

Step 400: Start.

Step 402: Download the metadata from the remote folder.

Step 404: Obtain the symmetric cryptographic key for the file according to the symmetric decrypting function of the metadata operating with the symmetric cryptographic key for the remote folder.

Step 406: Generate the updated ciphertext according to the symmetric encrypting function of the updated file operating with the symmetric cryptographic key for the file.

Step 408: Generate the updated metadata according to the symmetric encrypting function of the symmetric cryptographic key for the file operating with the symmetric cryptographic key for the remote folder.

Step 410: Upload the updated ciphertext and the updated metadata to the remote folder as the new version.

Step 412: End.

The process 50 includes the following steps:

Step 500: Start.

Step 502: Download the ciphertext and the metadata from the remote folder.

Step 504: Obtain the symmetric cryptographic key for the file according to the symmetric decrypting function of the metadata operating with the symmetric cryptographic key for the remote folder.

Step 506: Obtain the file according to the symmetric decrypting function of the ciphertext operating with the symmetric cryptographic key for the file.

Step 508: End.

The process 60 includes the following steps:

Step 600: Start.

Step 602: Download the metadata from the remote folder.

Step 604: Obtain the symmetric cryptographic key for the file according to the symmetric decrypting function of the metadata operating with the symmetric cryptographic key for the remote folder.

Step 606: Generate the new metadata according to the symmetric encrypting function of the symmetric cryptographic key for the file operating with the symmetric cryptographic key for the target folder.

Step 608: Upload the new metadata to the target folder.

Step 610: Move the ciphertext from the remote folder to the target folder, and delete the metadata in the remote folder.

Step 612: End.

Note that, the processes 30, 40, 50 and 60 are examples of the present invention, and those skilled in the art should readily make combinations, modifications and/or alterations on the abovementioned description and examples. For example, the symmetric encrypting and decrypting functions may be AES algorithms. Besides, without loss of generality, we assume the file resides in the remote (file) folder which is associated with the symmetric cryptographic key only known to the collaborators. The symmetric cryptographic key for the remote folder can be maintained in any way, such as a known key or a secret key, as long as the collaborators who have to access the file can know or obtain the symmetric cryptographic key for the remote folder.

In another aspect, when some encrypting algorithms requiring initialization vectors (IV) are employed, one has to update and record the corresponding file key IV (which is used along with the file key to encrypt the file content) whenever encryption is executed. This is because the same file key is used to encrypt all the revisions of a file. In other words, each file version needs a unique file key IV, which is suggested to be stored in the metadata of a file.

In the present invention, the computer device generates the ciphertext and the metadata according to the file, the symmetric cryptographic key for the file and the symmetric cryptographic key for the remote folder. Therefore, the file can be accessed and shared only for the members who have access rights to manage the file and keep secure and confidential.

To sum up, the present invention provides a method and apparatus for managing the file in the shared storage in the network system, to keep the file secure and confidential.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing a file in a remote folder in a shared storage in a network system, the method comprising:
generating a symmetric cryptographic key for the file;
generating a ciphertext according to a symmetric encrypting function of the file operating with the symmetric cryptographic key for the file;
generating a metadata according to the symmetric encrypting function of the symmetric cryptographic key for the file operating with a symmetric cryptographic key for the remote folder; and
uploading the ciphertext and the metadata to the remote folder.

2. The method of claim 1, the method further comprises:
downloading the metadata from the remote folder;
obtaining the symmetric cryptographic key for the file according to a symmetric decrypting function of the metadata operating with the symmetric cryptographic key for the remote folder;
generating an updated ciphertext according to the symmetric encrypting function of an updated file operating with the symmetric cryptographic key for the file;
generating an updated metadata according to the symmetric encrypting function of the symmetric cryptographic key for the file operating with the symmetric cryptographic key for the remote folder; and
uploading the updated ciphertext and the updated metadata to the remote folder.

3. The method of claim 1, the method further comprises:
downloading the ciphertext and the metadata from the remote folder;
obtaining the symmetric cryptographic key for the file according to a symmetric decrypting function of the metadata operating with the symmetric cryptographic key for the remote folder; and
obtaining the file according to a symmetric decrypting function of the ciphertext operating with the symmetric cryptographic key for the file.

4. The method of claim 1, the method further comprises:
downloading the metadata from the remote folder;
obtaining the symmetric cryptographic key for the file according to a symmetric decrypting function of the metadata operating with the symmetric cryptographic key for the remote folder;
generating a new metadata according to the symmetric encrypting function of the symmetric cryptographic key for the file operating with a symmetric cryptographic key for a target folder;
uploading the new metadata to the target folder;
moving the ciphertext from the remote folder to the target folder; and
deleting the metadata in the remote folder.

5. The method of claim 1, the method further comprises deleting the ciphertext and the metadata in the remote folder.

6. A computer readable medium comprising multiple instructions stored in a computer readable device, upon executing these instructions, a computer performing the following steps:
generating a symmetric cryptographic key for the file;
generating a ciphertext according to a symmetric encrypting function of the file operating with the symmetric cryptographic key for the file;
generating a metadata according to the symmetric encrypting function of the symmetric cryptographic key for the file operating with a symmetric cryptographic key for the remote folder; and
uploading the ciphertext and the metadata to the remote folder.

7. The computer readable medium of claim 6, wherein upon executing the instructions, the computer further performs the following steps:
downloading the metadata from the remote folder;
obtaining the symmetric cryptographic key for the file according to a symmetric decrypting function of the metadata operating with the symmetric cryptographic key for the remote folder;
generating an updated ciphertext according to the symmetric encrypting function of an updated file operating with the symmetric cryptographic key for the file;
generating an updated metadata according to the symmetric encrypting function of the symmetric cryptographic key for the file operating with the symmetric cryptographic key for the remote folder; and
uploading the updated ciphertext and the updated metadata to the remote folder.

8. The computer readable medium of claim 6, wherein upon executing the instructions, the computer further performs the following steps:
downloading the ciphertext and the metadata from the remote folder;
obtaining the symmetric cryptographic key for the file according to a symmetric decrypting function of the metadata operating with the symmetric cryptographic key for the remote folder; and
obtaining the file according to a symmetric decrypting function of the ciphertext operating with the symmetric cryptographic key for the file.

9. The computer readable medium of claim 6, wherein upon executing the instructions, the computer further performs the following steps:
downloading the metadata from the remote folder;
obtaining the symmetric cryptographic key for the file according to a symmetric decrypting function of the metadata operating with the symmetric cryptographic key for the remote folder;
generating a new metadata according to the symmetric encrypting function of the symmetric cryptographic key for the file operating with a symmetric cryptographic key for a target folder;
uploading the new metadata to the target folder;
moving the ciphertext from the remote folder to the target folder; and
deleting the metadata in the remote folder.

10. The computer readable medium of claim 6, wherein upon executing the instructions, the computer further performs deleting the ciphertext and the metadata in the remote folder.

11. A computer apparatus for a network system, comprising:
a processing means;
a storage unit; and
a program code, stored in the storage unit, wherein the program code instructs the processing means to execute the following steps:
generating a symmetric cryptographic key for the file;
generating a ciphertext according to a symmetric encrypting function of the file operating with the symmetric cryptographic key for the file;
generating a metadata according to the symmetric encrypting function of the symmetric cryptographic key for the file operating with a symmetric cryptographic key for the remote folder; and
uploading the ciphertext and the metadata to the remote folder.

12. The computer apparatus of claim 11, wherein the program code further instructs the processing means to execute:
downloading the metadata from the remote folder;
obtaining the symmetric cryptographic key for the file according to a symmetric decrypting function of the metadata operating with the symmetric cryptographic key for the remote folder;
generating an updated ciphertext according to the symmetric encrypting function of an updated file operating with the symmetric cryptographic key for the file;
generating an updated metadata according to the symmetric encrypting function of the symmetric cryptographic key for the file operating with the symmetric cryptographic key for the remote folder; and
uploading the updated ciphertext and the updated metadata to the remote folder.

13. The computer apparatus of claim 11, wherein the program code further instructs the processing means to execute:
downloading the ciphertext and the metadata from the remote folder;
obtaining the symmetric cryptographic key for the file according to a symmetric decrypting function of the metadata operating with the symmetric cryptographic key for the remote folder; and
obtaining the file according to a symmetric decrypting function of the ciphertext operating with the symmetric cryptographic key for the file.

14. The computer apparatus of claim 11, wherein the program code further instructs the processing means to execute:
downloading the metadata from the remote folder;
obtaining the symmetric cryptographic key for the file according to a symmetric decrypting function of the metadata operating with the symmetric cryptographic key for the remote folder;
generating a new metadata according to the symmetric encrypting function of the symmetric cryptographic key for the file operating with a symmetric cryptographic key for a target folder;
uploading the new metadata to the target folder;
moving the ciphertext from the remote folder to the target folder; and
deleting the metadata in the remote folder.

15. The computer apparatus of claim 11, wherein the program code further instructs the processing means to execute deleting the ciphertext and the metadata in the remote folder.
